(19) United States
(12) Patent Application Publication
(10) Pub. No.: US 2010/0052563 A1
(43) Pub. Date: Mar. 4, 2010

(54) Controller of Light Dimming and Overload Protection

(75) Inventors: Ye Guanrong, Hangzhou (CN); Ye Guanlin, Hangzhou (CN); Chou Shih Bin, Taipei (TW)

Correspondence Address: LIEBERMAN & BRANDSDORFER, LLC, 802 STILL CREEK LANE, GAITHERSBURG, MD, 20878, US

(73) Assignee: CANEL LIGHTING CO., LTD, Guangdong (CN)

(21) Appl. No.: 12/203,773

(22) Filed: Sep. 3, 2008

(51) Int. Cl. H05B 41/36

(52) U.S. Cl. 315/291

(57) ABSTRACT

A solution for mitigating interference from electrical signals emitted from a fluorescent lamp. The solution employs an electronic ballast and an electromagnetic filtering circuit. The ballast supports dimming of the fluorescent lamp. At the same time, the electromagnetic filtering circuit in communication with the electronic ballast mitigates emission of electronic disturbances from the lamp.

### BACKGROUND OF THE INVENTION

1. Technical Field

The present invention relates to florescent lighting. More specifically, the present invention relates to dimming a fluorescent lamp for a florescent light fixture and providing overload protection.

2. Description of the Prior Art

There are different categories of light fixtures known in the art. One category is known as a fixture that employs an incandescent light source to produce a visible light. Incandescence is known in the art as the emission of light from a hot body due to its temperature. More specifically, incandescence occurs in incandescent light bulbs as a result of a filament therein resisting the flow of electrons. This resistance heats the filament to a temperature, and part of the radiation emitted falls within the visible light spectrum.

Another category of light fixtures is known in the art as a fluorescent light fixture. A fluorescent fixture does not function by means of incandescence. Rather, a fluorescent fixture is a gas-discharge fixture that uses electricity to excite mercury vapor in argon or neon gas. The act of exciting the mercury vapor results in a plasma that produces short-wave ultraviolet light. This light then causes a phosphor to fluoresce, producing visible light, also known as a fluorescent light.

Unlike an incandescent light fixture, a fluorescent light fixture requires an electrical ballast to regulate the flow of power through the fixture. An electrical ballast, also known in the art as a control gear, is a device intended to limit the amount of current in an electric circuit. An electronic lamp ballast uses solid state electronic circuitry to provide the proper starting and operating electrical condition to power one or more fluorescent lamps. Electronic ballasts usually change the frequency of the power to eliminate a stroboscopic effect of flicker associated with fluorescent lighting.

Energy efficient fluorescent lamps can produce high levels of radio frequency, RF, interference. For a fluorescent lamp to operate at a high frequency, an electronic switching ballast is required. A dimming of the fluorescent lamp is achieved by reducing the power applied to the fluorescent lamp. In order to maintain the discharge, the frequency of operation must increase as the light output level is decreased. As a result, electronic ballasts can cause an increase in interference in portable radio receivers. Because the fundamental ballast operating frequency alters as the lamp is dimmed, the interference caused by the lamp depends upon the light output level of the unit.

In fact, switching power converters are a frequent source of RF emission problems, and those used in lighting products are no exception. In this case, the problem is compounded because fluorescent lamps are found in large numbers in many buildings and it is hard to find a location far enough away from emission interference.

Accordingly, there is a need for reducing electronic interference caused by the usage of fluorescent lamps to satisfy requirements or standards relating to electronic interference. In addition, if the lamp operating frequency approaches the resonance frequency, it creates a high voltage condition which may result in the failure of some electrical parts due to excessive heat. Accordingly, there is a need for overload protection pertaining to voltage, current, and capacitance.

### SUMMARY OF THE INVENTION

This invention includes an electrical component that mitigates interference caused by electrical signals emitted from a fluorescent lamp.

In one aspect, a fluorescent lamp is provided with an electronic ballast, an electromagnetic filtering circuit, and a control circuit. The electromagnetic circuit mitigates electronic disturbances. The electronic ballast is provided in communication with the electromagnetic filtering circuit, together with a control circuit to maintain the current in a circuit at a constant value. An oscillator and an output circuit are provided in communication with the control circuit. The filtering circuit supports dimming a light emission from the lamp while at the same time mitigating emission of an electronic disturbance from the ballast.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a circuit diagram for a light dimming controller according to one embodiment of the present invention, and is suggested for printing on the first page of the issued patent.

FIG. 2 is a top view of the circuit of FIG. 1 mounted on a substrate.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

A controller for a fluorescent lamp is provided to comply with standards associated with electronic interference. More specifically, the controller ensures that the lamp does not interfere with radio disturbance characteristics of industrial, scientific and medical (ISM) radio-frequency equipment.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

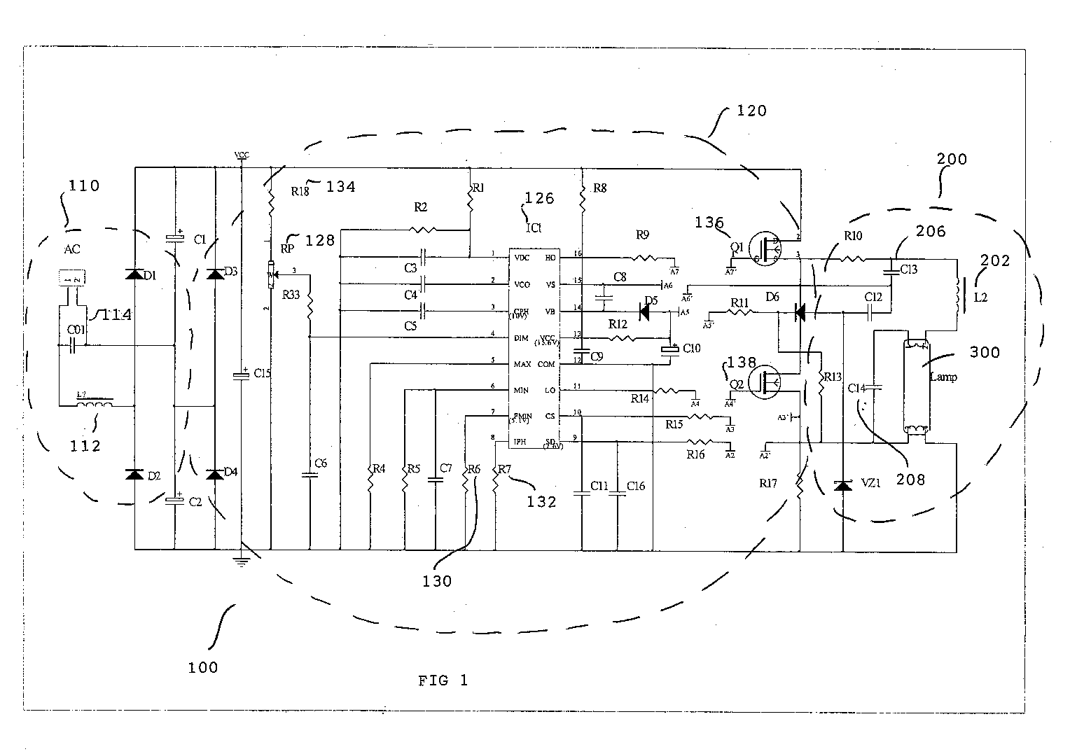

FIG. 1 is a circuit diagram (100) for a light dimming controller according to one embodiment of the present invention. The circuit diagram is comprised of four components, including an electromagnetic compatibility (EMC) circuit, hereinafter referred to as an EMC filtering circuit (110), a control circuit (120), an oscillator (200) and output circuit (250). Together, these components of the controller regulate emissions of signals creating electrical interference from a fluorescent lamp.

The EMC filtering circuit (110) of the controller includes an inductor (112) and a capacitor (114). The EMC filtering circuit (110) is provided to mitigate unwanted effects due to unintentional generation, propagation and reception of electromagnetic energy. More specifically, the EMC filtering circuit (110) addresses electronic disturbances. The goal of the EMC filtering circuit (110) is the correct operation, in the same electromagnetic environment, of different equipment which uses electromagnetic phenomena, and the avoidance of any interference effects. Accordingly, the EMC filtering circuit (110) reduces electronic disturbances caused by the usage of fluorescent lamps to levels that satisfy requirements of current standards.

The control circuit (120) of the controller is in communication with an electronic ballast (not shown). The ballast is a device that maintains the current in a circuit at a constant value by varying its resistance in order to counteract changes in voltage. The control circuit (120) for the electronic ballast includes integrated circuit (126), potentiometer (128), resistors (130), (132), and (134), and transistors (136) and (138). The integrated circuit (126) includes a dimming ballast controller and 600V half-bridge driver.

More specifically, the integrated circuit (126) simplifies dimming fluorescent lamp architecture into a single-chip solution. The integrated circuit (126) phase control loop architecture senses and regulates the phase current of the half-bridge. Only a single pin with an external current-sensing resistor is used to measure all feedback information necessary for pre-heat, ignition, dimming and lamp fault. The result is a closed loop system that simplifies linear dimming. The dimming effect is achieved by adjusting direct current voltage on the potentiometer (128) in a range from 0 to 5 V. Accordingly, the integrated circuit (126) in communication with the control circuit (120) supports dimming of the emitted light from the fluorescent lamp.

An oscillator and an output circuit (200) presented in FIG. 1 include an inductor (202), and capacitors (204), (206), and (208). The oscillator and output circuit (200) are in direct communication with the lamp (300).

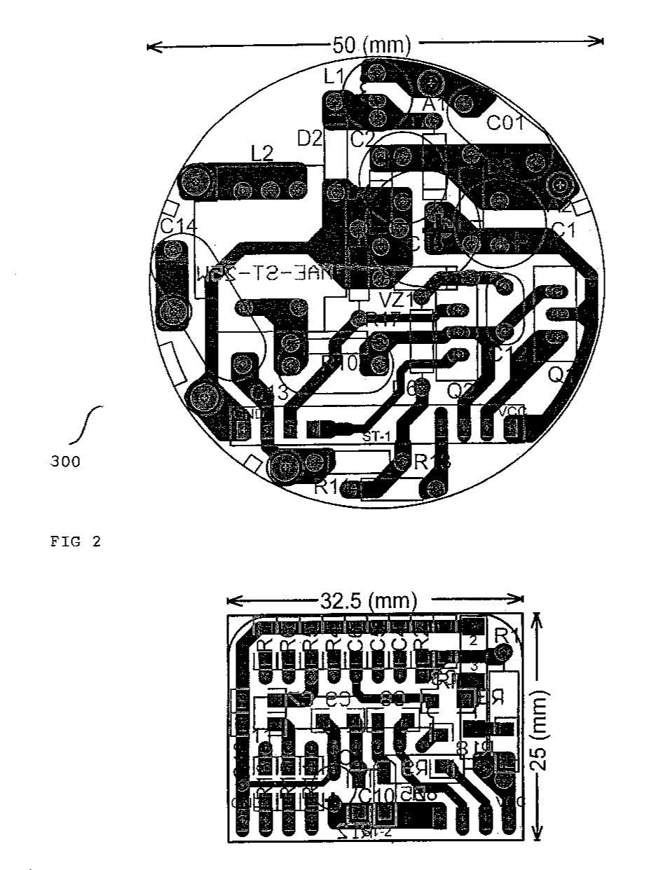

FIG. 2 is a top view (300) of the circuit and it's four primary components mounted on a substrate. In one embodiment, the substrate may be comprised of a semiconductor material. As shown, the substrate is small in size and has a diameter of about 50 mm.

The circuit with its four primary components, including the EMC filtering circuit (110), the control circuit (120) with its integrated circuit (126), the oscillator, and the output circuit (200), support a dimming affect on the subject lamp while mitigating emission of radio frequency to elements external to the fluorescent lamp. In one embodiment, an operating frequency with a minimum frequency of 45 KHz and a maximum frequency of 58 KHz is desired. At this range of frequencies, the components of the circuit support dimming of the subject fluorescent lamp with minimal or absence of a flicker affect from the emitting light, and minimal radio frequency interference.

It will be appreciated that, although specific embodiments of the invention have been described herein for purposes of illustration, various modifications may be made without departing from the spirit and scope of the invention. In particular, in one embodiment, the circuit with its components is mounted on the body of the subject luminary. The circuit with its components may also be suitable for direct use of other luminaries. Accordingly, the scope of protection of this invention is limited only by the following claims and their equivalents.

Externally programmable features such as preheat time and current, ignition-to-dim time, and a complete dimming interface with minimum and maximum settings provide a high degree of flexibility for a ballast design. Protection from failure of a lamp to strike, filament failures, thermal overload, or lamp failure during normal operation, as well as an automatic restart function is included in the design. The main part of this integrated circuit control is a voltage controlled oscillator with externally programmable minimum frequency.

We claim:

1. A fluorescent lamp comprising:
an electromagnetic filtering circuit to mitigate electronic disturbances;
an electronic ballast in communication with the electromagnetic filtering circuit, a control circuit in communication with the ballast to maintain the current in a circuit at a constant value; and
an oscillator and output circuit in communication with the control circuit, wherein the filtering circuit support dimming a light emission from the lamp while mitigating emission of an electronic disturbance from the ballast.

2. The lamp of claim 1, further comprising the ballast to support a dim affect of the lamp without flicker to the light emission from the lamp.

3. The lamp of claim 2, wherein said dim affect is supported at a minimum frequency of 45 KHz.

4. The lamp of claim 3, wherein said dim affect is support at a maximum frequency of 58 KHz.

5. The lamp of claim 2, further comprising mounting a dimmer on the body of the lamp.

6. The lamp of claim 2, wherein said filtering circuit mitigates radio frequency disturbance from the ballast at a range of 0 to 5 volts.

7. The lamp of claim 1, wherein the control circuit regulates electronic characteristics selected from the group consisting of: voltage, current, and capacitance.
